(19) United States
(12) Patent Application Publication
(10) Pub. No.: US 2006/0101620 A1
(43) Pub. Date: May 18, 2006

(54) Recliner handle extender

(76) Inventor: Jan Miller, Logan, UT (US)

Correspondence Address: Matthew S. Bethards;Stoel Rivers LLP, 201 South Main Street, Suite 1100, Salt Lake City, UT, 84111, US

(21) Appl. No.: 10/987,891

(22) Filed: Nov. 12, 2004

(51) Int. Cl. B25G 1/04

(52) U.S. Cl. 16/429

(57) ABSTRACT

A device for assisting individuals in actuating mechanisms that control positioning of furniture, like chairs, capable of achieving a reclining position. There is a handle extension device for attachment to a handle on a recliner furniture used to activate reclining positioning on the recliner furniture. Specifically, there is an attachment portion, designed to be attached to the handle. There is also a coupling assembly, designed to couple the attachment portion to the handle. Additionally, there is a gripping portion, extending from the attachment portion, designed to allow a user of the recliner to grip the gripping portion and actuate the handle that enables reclining of the reclining furniture.

### 1. CROSS-REFERENCES TO RELATED APPLICATIONS

This application claims the benefit of PCT patent application Ser. No. PCT/US03/16571, entitled RECLINER HANDLE EXTENDER, and filed on May 27, 2003 for Jan Lee. Miller, which claims priority to U.S. Provisional Patent Application No. 60/382,210, entitled RECLINER HANDLE EXTENDER, and filed on May 21, 2002 for Jan Lee. Miller.

### 2. FIELD OF THE INVENTION

The present invention relates to furniture, more particularly, there is a device for assisting individuals in actuating mechanisms that control positioning of furniture, like chairs, capable of achieving a reclining position.

3. DESCRIPTION OF THE RELATED ART

Reclining furniture, such as chairs, (hereinafter referred to as recliner(s)) of various shapes and designs are well known in the prior art and enjoyed by many as a source of comfortable seating. Recliners are appealing because they provide various positions for users to sit or recline. For individuals suffering from arthritis, back pain, or other ailments, recliners frequently offer the only source of relief. Additionally, elderly persons are also frequent users of recliners for various reasons.

There are, however, some common problems for many users in operating recliners. As suggested above, many users suffer from physical challenges that prevent them from independently operating the most important tool on the recliner—the recliner actuator, typically in the form of a lever or handle that is positioned on the side of the furniture piece. The main source of the problem specifically lies in the inability of many individuals to adequately reach and/or actuate the handle. For example, but by no means limiting to this particular problem, many recliner models position the handles in a position that is difficult to reach for many users, often being too low, short or close to the side of the furniture. Another common problem with handles is that they simply require too much force to actuate the reclining action of the furniture because the handles are often too short. Additionally, handles are needing to be short to prevent the ends thereof from detrimentally rubbing on typically inflated or pillowed arm rests that stick out past the vertical sides of the furniture. These problems, and others, have significantly reduced the number of persons able to benefit from the use of recliners.

The following patents teach various recliner related actuation devices, which are herein incorporated by reference for their supporting teachings:

(1) U.S. Pat. No. 5,282,395 issued to La Pointe et al., describes a detachable manual actuation handle for a recliner chair having a square shaped drive rod. The handle comprises a metal insert having a star shaped bore for receiving the free end of the drive rod in a plurality of alternate angular orientations.

(2) U.S. Pat. No. 5,056,862 issued to May et al., describes a reclining chair having a mechanism which releasably locks with the chair in its fully erect condition, is provided on one of its arms, with a recessed lever-type actuator.

(3) U.S. Pat. No. 4,188,062 issued to Rogers Jr. et al., describes a handle operated, wall-avoiding, recliner chair having a headrest which during normal or upright position of the chair is concealed behind the backrest.

(4) U.S. Pat. No. 4,337,977 issued to Rogers Jr. et al., describes a three way handle operated, wall avoiding, recliner chair with dual footrests. The handle is connected to a rear seat mounting link to move the seat forwardly to the base during which time a restraining mechanism prevents the backrest from moving relative to the seat.

The foregoing patents reflect the state of the art of which the applicant is aware and are tendered with the view toward discharging applicants' acknowledged duty of candor in disclosing information that may be pertinent in the examination of this application. It is respectfully stipulated, however, that none of these patents teach or render obvious, singly or when considered in combination, applicants' claimed invention.

### SUMMARY OF THE ILLUSTRATED EMBODIMENT(S)

It is a feature of the illustrated embodiment(s) is to provide a device for assisting individuals in actuating mechanisms that control positioning of furniture, like chairs, capable of achieving a reclining position.

A feature of the illustrated embodiment is to provide a handle extension device (10) for attachment to a handle (52) on a recliner furniture (60) used to activate reclining positioning on the recliner furniture. Specifically, there is an attachment portion (55), designed to be attached to the handle. There is also a coupling assembly (14), designed to couple the attachment portion to the handle. Additionally, there is a gripping portion, extending from the attachment portion, designed to allow a user of the recliner to grip the gripping portion and actuate the handle that enables reclining of the reclining furniture.

Another feature of the illustrated embodiments is that the gripping portion angles (34) away from the reclining furniture (60). Additionally, the gripping portion may have a first portion (44), coupled to the attachment portion (55), extending away from a center line (51) of the handle to have a closer proximity to an arm of the reclining furniture than the handle does. The gripping portion further may have a second portion (40), coupled to the first portion (44), extending away from the first portion so as to extend toward the center line (51) of the handle to have a further proximity to an arm of the reclining furniture than the first portion. Also, the gripping portion may have a third portion (42), coupled to the second portion (44), extending away from a center line (51) of the handle to have a farthest proximity to an arm of the reclining furniture than the handle does.

There has thus been outlined, rather broadly, the more important features of the invention so that the detailed description thereof that follows may be better understood, and so that the present contribution to the art may be better appreciated. Those skilled in the art will appreciate that the conception, upon which this disclosure is based, may readily be utilized as a basis for the designing of other structures, methods and systems for carrying out the several purposes of the present invention. It is important, therefore, that the claims are regarded as including such equivalent constructions insofar as they do not depart from the spirit and scope of the present invention.

### BRIEF DESCRIPTION OF THE ILLUSTRATED EMBODIMENT(S)

It is noted that the drawings of the invention are not to scale. The drawings are merely schematic representations, not intended to portray specific parameters of the invention. The drawings are intended to depict only typical embodiments of the invention, and therefore should not be considered as limiting the scope of the invention. The invention will be described with additional specificity and detail through the use of the accompanying drawings. It is noted that similar numbering between figures represent the same elements. Wherein the drawings are as follows:

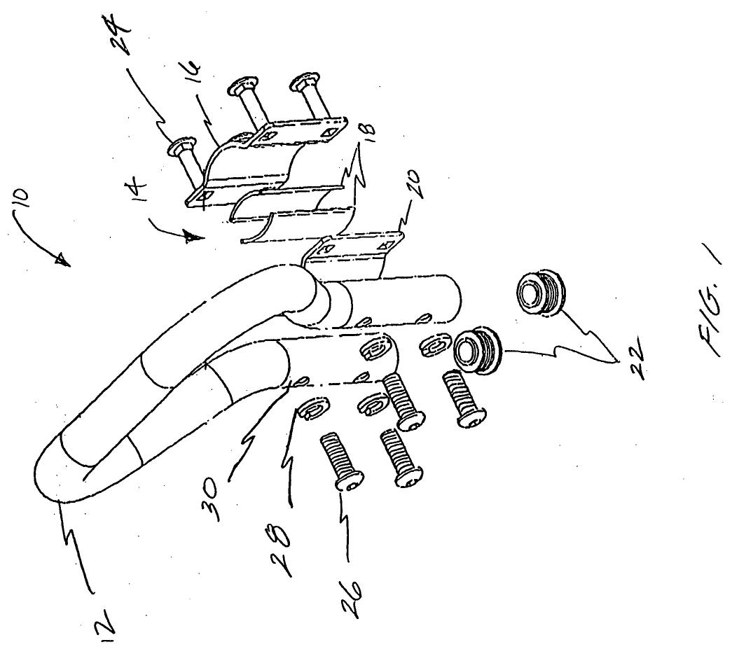

FIG. 1 is a perspective view of potential parts to make up the illustrated embodiment;

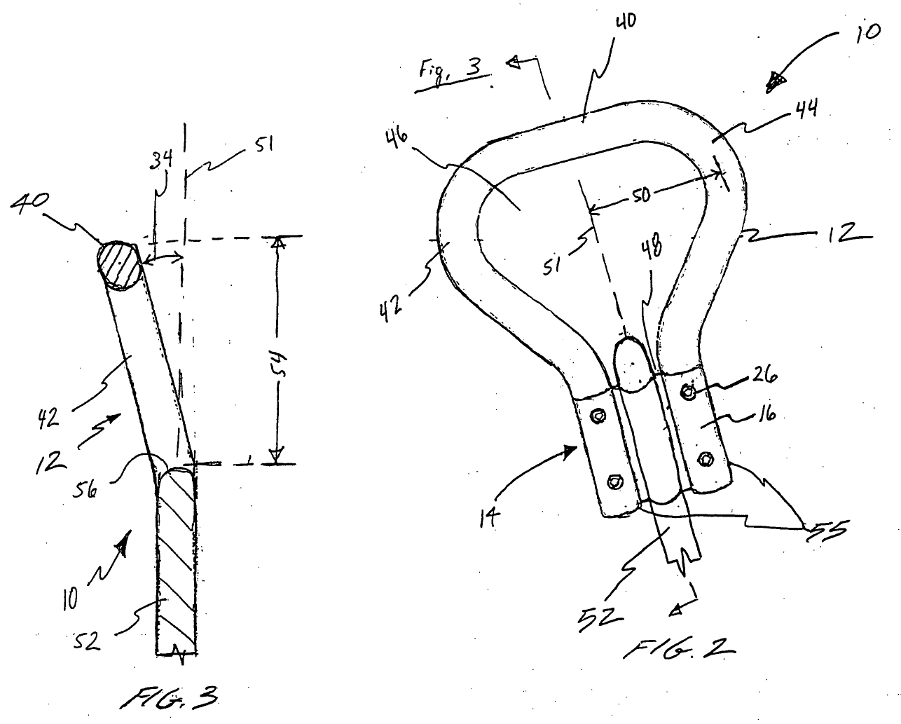

FIG. 2 is a side view of the illustrated embodiment in FIG. 1;

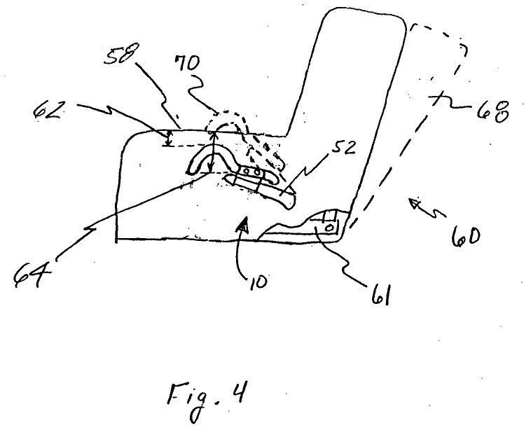

FIG. 3 is a sectioned side view of FIG. 2; and

FIG. 4 is a side view of the illustrated embodiment as used on a recliner chair.

### DETAILED DESCRIPTION OF THE ILLUSTRATED EMBODIMENT(S)

Referring to FIG. 1, there is shown a perspective view of the illustrated embodiment. In particular, there is a recliner handle extender 10, which includes a gripping portion or handle tubing 12, and a mounting or coupling assembly 14 used for mounting the extender 10 to a recliner handle (not shown). The mounting assembly 14 has various miscellaneous pieces, such as, a bottom bracket 16, which is typically shaped to match the contour of the underside of an intended recliner handle, which is intended to be clamped thereto. Additionally, there may be a handle stabilizer 18, which is illustrated as a pair of brackets, again shaped to typically match the contours of the topside and underside of recliner handle. Stabilizer 18 is may also help protect the recliner handle from scratches and/or dents. The mounting assembly further may include a top bracket 20, also shaped to match the contour of an intended recliner handle, which is designed to clamp to the topside of the recliner handle. There may also be a male screw 26 and female receiving shaft 24 as illustrated, which operate as commonly known in the industry. It may be advantageous for the male screw 26 to have the receiving shaft designed with a square-shaped neck that corresponds to a square-shaped shaft hole on the bottom bracket 16, which would be used to stabilize the female receiving shaft during tightening of the male screw 26. There is also illustrated an optional washer 28, which is designed to protect the handle tubing 12 from direct contact with the head of the male screw 26. Additionally, there is also illustrated a screw hole 30, designed to allow passage of the female receiving shaft 24 and the male screw 26. Finally, there is illustrated end caps 22 that are designed to plug the ends of the lever extender 10.

Referring now to FIG. 2, there is illustrated a side view of the illustrated embodiment in FIG. 1. In particular, there is a handle extender 10 that is secured to a typically designed recliner handle 52. The distance gained from the center line of the handle 51 to the center line of the rounded portion of the handle tubing portion 12 makes it easier for the recliner user to actuate the recliner by effectively raising the grip point. Uniquely, there is illustrated a top handle portion 40, located, as illustrated, on the top-side of the rounded portion of the handle tubing 12. There is also a left-side handle 42 shows the left-side of the rounded portion of the handle tubing 12. Similarly, there is a right-side handle portion 44, located on the right-side of the rounded portion of the handle tubing 12. Handle portions 40, 42 and 44 serve as gripping portions for a user to grasp during the actuation of the lever extender 10. There is a grip space 46, illustrated as a large space between the left-side handle 42 and the right-side handle portion 44 that is used for enabling a hand of a user to reach in and grip or hold on to the handle tubing 12 at various locations. It is noted that there may be an optional handle space 48, which is a small space between the handle ends 55 of the handle tubing 12 for inserting a handle 52 therein without contacting the tubing ends 55. Tubing ends 55 are also referred to as base portions or attachment portion 55. It is further noted that there is a distance 50, located between center line 51 and the center line of the rounded portion of the handle tubing 12, which is illustrated to be at right-side handle portion 44. As is typical drawing convention, center line 51 extends down the center of the recliner handle 52, as illustrated. It is additionally noted that recliner handle 52 is inserted into the mounting bracket assembly 14 and thereby is secured to the recliner extender 10. A skilled artisan will understand that the purpose of the base ends 55 of the handle tubing 12, is to provide an attachment platform upon which the mounting bracket assembly 14 is secured to both the recliner handle 52 and the lever extender 10.

FIG. 3 is a sectioned side view of FIG. 2. Specifically, there is illustrated that the handle extender 10 and the handle tubing 12 form an angle 34 of varying degree. The distance gained from the end of the handle 56 to the end of the top-side handle 40 makes it easier for the recliner user to operate the recliner by adding leverage and decreasing the amount of force required to actuate the recliner. The mounting bracket assembly 14 is not shown. Uniquely, angle 34 extends between any flat portion of the handle portions 40, 42, and 44, which are on a common plane, and the center line 51 from recliner handle 52. It is contemplated to have angle 34 form an angle of varying degree between about 0 and 90 degrees. The angle is chosen to provide the optimal amount of leverage for a recliner user to benefit from, and to avoid contact with any protruding part from a furniture recliner, such as an arm cushion. It is noted that there is a extension distance 54 that is measured from a top end 56 of handle 52 to the top-side 40 of extension handle or lever extender 10.

One of ordinary skill in the art of designing levers and such will realize many advantages from using the preferred embodiments taught herein. For example, referring to FIG. 4, there is illustrated a side view of a handle extender 10, secured to a handle 52 on the left side of a reclining piece of furniture or recliner 60 having a reclining mechanism 61 positioned within the recliner 60 in a typical and well known fashion in the prior art. It is noted that there is a decrease in the distance between the needed reach distance for a user to actuate the old handle 52 and the lever extender 10. Specifically, distance 62 is measured from lever extender side portion 44 to the top of the chair arm or arm rest 58, and distance 64 is measured from the end of the recliner handle 56 and the chair arm top 58. A skilled artisan will understand that it is illustrated that there is a distinct advantage in both increased leverage for a user and a decreased reaching distance for a user by implementing this illustrated embodiment. Specifically, by having a longer lever, the amount of force needed to move or rotate the lever will be decreased by gripping the end of the lever extender 10 for standard actuation.

The reclining position 68 of the recliner furniture 60 is illustrated in phantom lines. Similarly, the lever extender 10 and handle 52 are illustrated in phantom lines while in a reclining actuation position 70.

It is noted that when the extender lever 10 is actuated, the extender lever is moved typically upward. If the chair arm 58 is pillowed or puffed out, or the handle 52 is typically too close to the side of the chair, the lever extender 10 will miss detrimental rubbing therewith because of the angle 30 formed therebetween, as illustrated in FIG. 3.

### Variations of the Preferred Embodiment(s)

It is noted that in a skilled artisan would understand that there are many potential materials available for use in an application for fashioning a recliner handle extender 10. For example, wood, metal and plastic would all accomplish the intended purpose of providing an easy to grip extension to a recliner handle. Furthermore, one skilled in the art would understand that varying methods of fastening the mounting bracket assembly 14 to the handle tubing 12 and to a recliner handle are contemplated. For example, holes may be drilled into a recliner handle through which and female receiving shaft 24 and a male screw 26 may be passed to increase stability.

The shape of the lever extender 10 may also be modified to achieve the functions of raising the grip point of the handle and/or decreasing the amount of force required to actuate the recliner. For example, one base end 55 of the extender 10 may be eliminated for aesthetic or other purposes. Additionally, the actual shape of the overall design may be most any shape, provided that there is an extended portion beyond the recliner handle 52. Specifically, a simple straight rod design could work by attaching it to the handle 52 and extending outward therefrom. A skilled artisan in handle designs could design an infinite number of designs for the gripping portion (that portion extending from the handle 52), thus, these drawings have only illustrated one embodiment of the lever extender 10.

Again, although angle 34 has been illustrated, there are recliner designs that may not need the angle to avoid harmful contact with the recliner surfaces. Even mild contact can be tolerated by many fabrics, and this non-contact may not be absolutely essential. However, it is noted that typical recliners have arm rests that often stick out further then the sides of the recliner. The handle 52 is typically parallel to the sides of the recliner and is often positioned to barely miss rubbing the sides of the recliner when being actuated. Thus, if the arm is extending away from the sides of the recliner, then an angle to the extending lever 10 is required to allow a user to pull up on it without bumping into or detrimentally rubbing against the arm 58.

Additionally, bracket assembly 14 is intended only to illustrate one method of attachment between the recliner handle 52 and lever extender 10. Specifically, glues, screws, bolts, elastics, clips, and sleeves may all be examples of methods of attachment. In fact a skilled artisan of attachment devices and methods would easily design any number of attachment means given the many design variations possible for the lever extender 10 shape. One shape that may be desirable is to attach a receiving tube at the end of base portion 55, wherein handle 52 could slide into the receiving tube and the receiving tube could slide over handle 52. This would operate much like a lipstick cover fitting over the lipstick container or holder, where the cover is the receiving tube and the lipstick holder is the recliner handle 52. One skilled in the art would expect that the rest of the extender 10 would extend off of the lipstick cover and be parallel to center line 51. Finally, considerable variations on the width, length, and formed angle are contemplated.

Although the present invention is described as an add-on extender for an existing handle of a recliner, it is contemplated to use the key features of the present invention to permanently alter the design of recliner handles. Specifically, the handle would become the base part 55 and the sides and top of the handle would be integral thereto. Thus, recliners would be sold with the current key patentable features of the present invention without having to retrofit the larger handle arrangement thereon. This permanently modified handle feature also contemplates having only one base section 55 and not two, as illustrated, since most handles 52 (now the base) would be made strong enough to not need two base portions. Also, only a single side 44, for example, would be required, since the retrofit design described herein is designed to fit both a right and left mounted unit, and this flexibility of mounting would not be required for a handle 10 that is already integral to handle 52. Specifically, only one side 44 and an optional top portion 40 may be required. The shape of the side portion 44 would not need to be the same as illustrated, as previously discussed, most any shape would be suitable, even a straight or curved rod.

While the invention has been taught with specific reference to these embodiments, someone skilled in the art will recognize that changes can be made in form and detail without departing from the spirit and the scope of the invention. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. An extension device for attachment to a handle on a reclinable furniture used to activate reclining positioning on the reclinable furniture, comprising:
an attachment portion designed to extend along a side of the handle to operate a reclining mechanism on the reclinable furniture, wherein the handle has a holding portion at a distal end of the handle;
a clamping mechanism attached to the attachment portion and designed to clamp the attachment portion to the holding portion of the handle; and
a gripping portion, extending from the attachment portion, designed to allow a user of the reclinable furniture to grip the gripping portion and actuate the handle, wherein the gripping portion has an initial inclination section proximate to the clamping mechanism sufficient to avoid detrimental contact to a reclinable furniture arm rest.

2. The device of claim 1, wherein the gripping portion is inclined from the clamping mechanism from one to ninety degrees.

3. The device of claim 1, wherein the initial inclination section begins abutting to the clamping mechanism.

4. The device of claim 1, wherein the gripping portion is completely linear as extended from the initial inclination section.

5. The device of claim 1, wherein the gripping portion comprises:
a first portion, coupled to the attachment portion, extending away from a center line of the handle to have a closer proximity to an arm of the reclinable furniture than the handle does.

6. The device of claim 5, wherein the gripping portion further comprises:
a second portion, coupled to the first portion, extending away from the first portion so as to extend toward the center line of the handle to have a further proximity to an arm of the reclinable furniture than the first portion.

7. The device of claim 6, wherein the gripping portion comprises:
a third portion, coupled to the second portion, extending away from a center line of the handle to have a farthest proximity to an arm of the reclinable furniture than the handle does.

8. The device of claim 7, wherein the third portion being additionally coupled to the attachment portion, and designed to mirror the design of the first portion.

9. The device of claim 1, wherein the coupling assembly couples over an end portion of the handle and over the attachment portion of the handle extension device in a fashion that maintains the attachment portion and the handle in a parallel orientation.

10. The device of claim 8, wherein the coupling assembly couples over an end portion of the handle and over the attachment portion of the handle extension device in a fashion that maintains the attachment portion and the handle in a parallel orientation.

11. An extension device for attachment to a handle on a reclinable furniture used to activate reclining positioning on the reclinable furniture, comprising:
an attachment portion designed to extend along a side of the handle to operate a reclining mechanism on the reclinable furniture, wherein the handle has a holding portion at a distal end of the handle;
a clamping mechanism attached to the attachment portion and designed to clamp the attachment portion to the holding portion of the handle; and
a gripping portion, extending from the attachment portion, designed to allow a user of the reclinable furniture to grip the gripping portion and actuate the handle, wherein the initial inclination section of the gripping portion is not at a distal end which is located opposite to the attachment portion.

12. The device of claim 11, wherein the gripping portion is inclined from the clamping mechanism from one to ninety degrees.

13. The device of claim 1 1, wherein the initial inclination section begins abutting to the clamping mechanism.

14. The device of claim 11, wherein the gripping portion is completely linear as extended from the initial inclination section.
